(19) United States
(12) Patent Application Publication
(10) Pub. No.: US 2019/0025744 A1
(43) Pub. Date: Jan. 24, 2019

(54) IMAGE FORMING APPARATUS

(71) Applicant: CANON KABUSHIKI KAISHA, Tokyo (JP)

(72) Inventors: Masaki Hirose, Suntou-gun (JP); Satoru Taniguchi, Mishima-shi (JP); Takashi Honke, Mishima-shi (JP); Hirohiko Aiba, Suntou-gun (JP); Taisuke Minagawa, Suntou-gun (JP); Mahito Yoshioka, Numazu-shi (JP)

(21) Appl. No.: 16/041,012

(22) Filed: Jul. 20, 2018

(30) Foreign Application Priority Data
Jul. 21, 2017 (JP) 2017-141665

(51) Int. Cl. G03G 15/00; G03G 15/20

(52) U.S. Cl. CPC G03G 15/5062; G03G 15/2039

(57) ABSTRACT

An image forming apparatus includes an image forming portion for forming a toner image on a sheet; a fixing portion for heating and fixing the toner on the sheet; and a controller for controlling the apparatus which is operable to form an image on the sheet having a first size and the sheet having a second size smaller than the first size. When a print instruction on the sheet of the first size during a period in which a print is formed on the sheet of the second size at a first throughput, the controller controls the apparatus so as to print on the sheet of the second size at a second throughput which is lower than the first throughput.

### FIELD OF THE INVENTION AND RELATED ART

The present invention relates to an image forming apparatus, such as a copying machine and a printing machine, for forming a toner image on a sheet of recording medium with the use of an electrophotographic recording technology.

As a substantial number of small prints are outputted in succession by an image forming apparatus which employs a fixing device, the portions of the fixing nip, which are out-of-sheet-path, gradually overheat. Hereafter, this phenomenon will be referred to as “out-of-sheet-path overheating”. It is likely that as the out-of-sheet-path portions of the fixation nip overheat, various internal parts (fixing members which form fixation nip) of the fixing apparatus are damaged. Further, it sometimes occurs that as a large sheet (sheets) of recording medium is conveyed through the fixing device right after the successive conveyance of a substantial number of small sheets of recording medium, the toner particles on the out-of-sheet-path portions of the large sheet of recording medium, are excessively heated, and are offset onto the abovementioned rotational members (fixation film, for example) of a fixing device. Hereafter, this phenomenon may be referred to as “high temperature offset”.

In recent years, the fixing portion of a fixing apparatus has been progressively decreased in thermal capacity, in order to reduce an image forming apparatus in FPOT (First Print Out Time), and also, to reduce an image forming apparatus in energy consumption. This means that the fixing members of a recent fixing device are likely to quickly increase in temperature even when the amount by which heat is given to them is relatively small. Thus, the out-of-sheet-path portions of a recent fixing device are likely to increase in temperature faster than those of a conventional fixing device, because they are less in thermal capacity than the counterparts of a conventional fixing device. This is undesirable from the standpoint of minimizing the out-of-sheet-path overheating.

Further, in recent years, an image forming apparatus has been substantially increased in printing speed. As an image forming apparatus has been increased in speed, it has become more likely for the out-of-sheet-path portions of a fixing device to overheat, for the following reason. That is, the shorter is the length of time it takes for a sheet of recording medium to pass through the fixing portion, the larger is the amount by which the fixing device (heating portion) needs to be supplied with electric power per unit length of time, and therefore, the greater the amount of the heat given to the out-of-sheet-path portion per unit of length of time. Moreover, as an image forming apparatus has been increased in printing speed, it has become shorter in the sheet interval in an image forming operation in which two or more prints are outputted in succession. Thus, it has become less likely for the portion of the fixation nip, which corresponds in position to the sheet path, and the portions of the fixation nip, which are out of the sheet path, to become practically equal in temperature with each other, during the sheet interval. Here, “sheet interval” means the length of time between when the trailing end of the preceding sheet of recording medium comes out of the fixation nip, and when the leading end of the immediately following sheet of recording medium enters the fixation nip, in an image forming operation in which two or more prints are outputted in succession.

One of the means for minimizing the out-of-sheet-path overheating is proposed in Japanese Laid-open Patent Application No. H07-191571. According to this patent application, if it is determined, at the beginning of an image forming operation, that the out-of-sheet-path portions of the fixation nip are excessively high in temperature, such a process as idling the fixation roller is carried out to make the sheet-path portion of the fixation nip and the out-of-sheet-path portions of the fixation nip roughly equal in temperature.

However, as an image forming apparatus is increased in printing speed, the length of time it takes to make the fixing nip more or less uniform in temperature in terms of its lengthwise direction becomes relatively longer compared to the actual length of time it takes to output prints. Thus, the total length of time it takes to finish an image forming operation in which a certain number of large prints are outputted after a substantial number of small prints are outputted becomes substantially longer than the length of time it takes when the image forming apparatus is conventionally operated. That is, proposals such as the abovementioned one are problematic in that they substantially reduce an image forming apparatus in productivity.

### SUMMARY OF THE INVENTION

Thus, the primary object of the present invention is to provide an image forming apparatus which can output high quality images, while remaining virtually the same in productivity as it is in an ordinary image forming operation, even in an image forming operation in which large sheets of recording medium are conveyed through the fixation nip immediately after a substantial number of small sheets of recording medium are conveyed through the fixation nip in succession.

According to an aspect of the present invention, there is provided an image forming apparatus comprising an image forming portion configured to form a toner image on a recording material; a fixing portion configured to heat and fix the toner image formed on the recording material; and a controller configured to control said apparatus which is operable to form an image on the recording material having a first size and the recording material having a second size smaller than the first size, wherein when a print instruction on the recording material of the first size during a period in which a print is formed on the recording material of the second size at a first throughput, said controller controls said apparatus so as to print on the recording material of the second size at a second throughput which is lower than the first throughput.

Further features of the present invention will become apparent from the following description of exemplary embodiments with reference to the attached drawings.

### BRIEF DESCRIPTION OF THE DRAWINGS

FIG. 1 is a sectional view of the image forming apparatus in the first embodiment of the present invention; it shows the overall structure of the apparatus.

FIG. 2 is a sectional view of the fixing portion of the so-called film-heating type in the first embodiment; it shows the overall structure of the heating portion.

FIG. 3 is a graph which shows the relationship between the temperature difference between the sheet-path portion and out-of-sheet-path portion of the fixing portion, and the elapsed length of time, while images are actually formed, and while the fixing portion is cooled (equalization process).

FIG. 4 is a flowchart of the throughput-down control sequence in the first embodiment.

FIG. 5 is a graph which shows the relationship between the throughput and the number of sheets conveyed through the fixation nip, when the throughput-down control was carried out and when the throughput-down control was not carried out.

FIG. 6 is a graphical drawing for showing the length by which the total length of time required to complete an image forming operation can be reduced.

FIG. 7 is a sectional view of the fixing portion in the second embodiment of the present invention; it is for showing the positioning of the two temperature detection elements.

FIG. 8 is a graph which shows the relationship between the difference between the temperature detected by one of the two temperature detection elements, and that detected by the other temperature detection element, and the difference between temperature of the sheet-path portion of the fixation film and that of the out-of-sheet-path portions of the fixation film.

FIG. 9 is a flowchart of the throughput-down control sequence in the second embodiment of the present invention.

### DESCRIPTION OF THE EMBODIMENTS

Hereinafter, a few of preferred embodiments of the present invention are described with reference to appended drawings.

### Embodiment 1

### (Image Forming Apparatus)

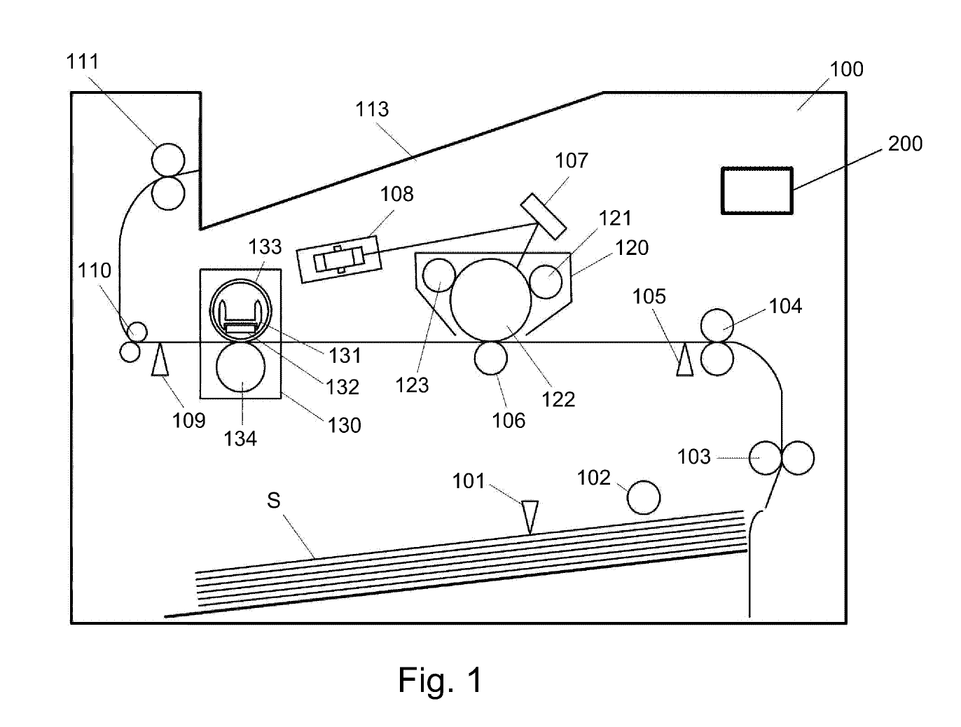

FIG. 1 is a sectional view of the image forming apparatus in this embodiment. It shows the overall structure of the apparatus. First, referring to FIG. 1, the overall structure and printing operation (image forming operation) of this image forming apparatus are described.

The image forming apparatus 100 in this embodiment employs a toner cartridge 120 which is removably mountable in the main assembly of the apparatus 100. The toner cartridge 120 is provided with a development roller 121, a photosensitive drum 122, and a charge roller 123. It is one of the members which make up the toner image forming portion of the apparatus 100.

As a printing operation is started, first, the peripheral surface of the photosensitive drum 122 is uniformly charged to a preset potential level by the charge roller 123. To the uniformly charged portion of the photosensitive drum 122, a beam of laser light, which is outputted from an optical box 108 (laser) and is deflected by a mirror 107, is projected. This beam of laser light is such a beam of laser light that is outputted by the optical box 108 while being modulated (turned on or off), in accordance with the information which is related to the image to be formed, and which is inputted from an apparatus (unshown), such as an image reading apparatus and a computer.

More concretely, the uniformly charged portion of the peripheral surface of the photosensitive drum 122 is scanned (exposed) by the beam of laser light. Consequently, a latent image (electrostatic latent image) which reflects the information of the image to be formed, is formed on the peripheral surface of the photosensitive drum 122. The timing with which the peripheral surface of the photosensitive drum 122 begins to be scanned in the secondary direction is given by secondary scanning timing synchronization signals given from the image forming apparatus to the image formation signal generating apparatus. The latent image formed in accordance with the information of the image to be formed is developed by the development roller 121.

Next, as it is detected by a recording medium (recording paper) sensor 101 that sheets S of recording medium are present in a sheet feeder cassette, one of the sheets S is fed into the main assembly of the image forming apparatus 100 by a feed roller 102. Then, the sheet S is conveyed further by a conveyance roller 103, and a pair of registration rollers 104. As the sheet S is conveyed, the leading edge of the sheet S is detected by an edge sensor 105 to convey the sheet S further with such timing that the sheet S arrives at the transfer nip, which is the nip between the photosensitive drum 122 and a transfer roller 106, at the same time as the toner image on the peripheral surface of the photosensitive drum 122.

The transfer roller 106 is for transferring a toner image from the photosensitive drum 122 onto the sheet S. More specifically, as electrical charge which is different in polarity from the normal toner charge is applied to the sheet S from the back side of the sheet S by the transfer roller 106, the toner image is transferred from the photosensitive drum 122 onto the sheet S. After the transfer of the toner image onto the sheet S, the sheet S is separated from the photosensitive drum 122, and then, is sent to a fixing portion 130, through which it is conveyed. As the sheet S is conveyed through the fixing portion 130, it is heated and pressed. Consequently, the unfixed toner image on the sheet S becomes fixed to the sheet S. The fixing portion 130 has a guiding member 131, a heater 132, a film 133 (endless belt), and a pressure roller 134, as will be described later.

After the fixation of the toner image to the sheet S, the sheet S is conveyed out of the fixing portion 130, and then, is conveyed further. Then, the leading edge of the sheet S is detected by a discharge sensor 109. Then, the sheet S is conveyed further by a pair of FU rollers 110 and a pair of FD rollers 111, and is discharged into a FD tray 113 (delivery tray), ending the printing sequence.

As for the specifications of the image forming apparatus 100 in this embodiment, the image forming apparatus 100 is 160 mm/sec in process speed, and is 15 ppm (when recording medium is small sheet (envelop) of COM10 size). Here, “throughput” means the number of images (prints) which the image forming apparatus 100 can output per unit length of time (number of images which fixing portion can fix per unit length of time). In terms of the recording medium conveyance direction, the dimension of the widest sheet on which this image forming apparatus 100 can form an image is 210 mm (which is equivalent to width of sheet of recording medium of A4 size when it is conveyed in portrait mode). When a sheet of recording medium of A4 size is conveyed in portrait mode, the throughput of the image forming apparatus 100 is 60 ppm.

### (Fixing Portion)

Next, the fixing portion 130 of the image forming apparatus 100 in this embodiment is described.

An image forming apparatus equipped with a fixing portion can accommodate various recording mediums (recording papers (sheets)) which are different in dimension in terms of the widthwise direction, that is, the direction which is perpendicular to the direction in which a sheet of recording medium (paper) is conveyed through the fixing portion (image forming apparatus). Hereafter, the widest sheet of recording paper which the image forming apparatus 100 can accommodate is referred to as a “large sheet of paper”, whereas any sheet of recording paper, which is narrower than the large sheet of paper is referred to as a “small sheet of paper”. Further, the excessive amount of temperature increase which occurs to the lengthwise end portions of each of a pair of fixing members which form the nip, as a substantial number of small prints are outputted in succession, is referred to as “out-of-sheet-path overheating”.

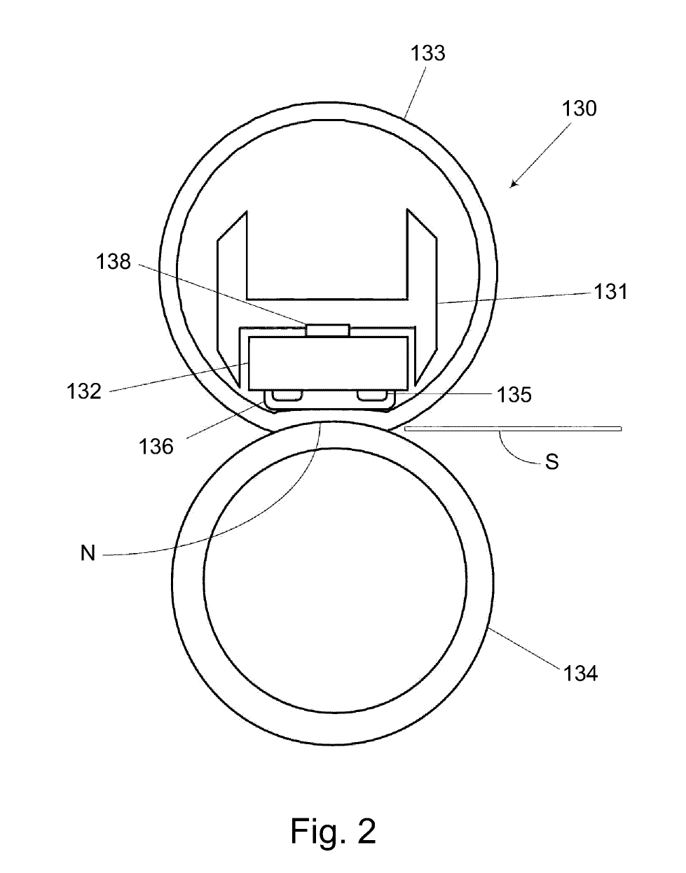

FIG. 2 is a sectional view of the fixing portion 130 of the film-heating type. It shows the overall structure of the fixing portion 130. The fixing portion 130 has: a heater 132 (heating member); a guiding member 131 (holding member) for holding the heater 132; a heat-resistant endless (cylindrical) film 133 (first rotational member) fitted around the guiding member 131; and a pressure roller 134 (second rotational member) as a pressing member. The area of contact between the film 133 and pressure roller 134 is the fixation nip N (which hereafter may be referred to simply as nip N), which corresponds in position to where the heater 132 faces the inward surface of the film 133.

Here, a combination of the film 133 which is referred to as the first fixing member, and the pressure roller 134 which is referred to as the second fixing member, is equivalent to a pair of rotational members which form the nip N by being pressed upon each other. Further, the heater 132 is in contact with the inward surface of the film 133. Next, each of the structural components of the fixing portion 130 is described.

### 1) Guiding Member 131

The guiding member 131 is formed of heat resistant resin. Not only does it support the heater 132, but also, doubles as a conveyance guide for the film 133. As the materials for the guiding member 131, highly heat resistant resin such as polyimide, polyamideimide, polyether-ether-ketone, polyphenylene-sulfide, and liquid polymer, which are easily processible, are usable. Further, composite materials made of these resins, ceramics, metals, glasses, etc., can also be usable. In this embodiment, liquid polymer was used.

### 2) Heater 132

The heater 132 is a ceramic heater. As the heater substrate, a ceramic substrate (which hereafter will be referred to simply as substrate), which is excellent in terms of thermal conductivity and is dielectric, is used. It is made of such ceramic as alumina and aluminum nitride. From the standpoint of reducing the substrate in thermal capacity, the thickness of the substrate is desired to be in a range of roughly 0.5-1.0 mm. The substrate is rectangular, and is roughly 10 mm in width and roughly 300 mm in length.

The heater 132 has a heat-generating resistor 135, which is borne by one of the pair of largest surfaces of the substrate, extending in the lengthwise direction of the substrate. The main ingredient of the heat-generating resistor 135 is silver-palladium alloy, nickel-tin alloy, ruthenium oxide alloy, or the like. It is roughly 10 μm in thickness, and roughly 1-5 mm in width. It is formed on the substrate by screen printing or the like method.

Further, the heater 132 is provided with a glass layer 136 as an electrically insulative layer, which covers the top side of the heat-generating resistor 135. Not only does the glass layer 136 insulate the electrically conductive layer of the film 133 from the heat-generating resistor 135, but also, plays the role of preventing the heat-generating resistor 135 from suffering from mechanical damages. The thickness of the glass layer 136 is desired to be in a range of 20-100 μm. The glass layer 136 plays also the role of a layer on which the film 133 slides.

### 3) Film 133

The film 133 which is an endless belt is fitted around the guiding member 131 by which the heater 132 is held. The relationship between the dimension of the film 133 and that of the guiding member 131 is such that the dimension of the inward surface of the film 133 in terms of its rotational direction is greater than the circumference of the theoretical cylinder which circumscribes the guiding member 131 by which the heater 132 is held. Thus, the film 133 loosely fits around the guiding member 131.

The film 133 has to be capable of efficiently transferring the heat from the heater 132 to a sheet of recording medium as an object to be heated. Thus, it is formed of a single-layer film formed of heat resistant resin such as PTFE, PFA and FEP, or a multilayer film formed of two or more of these resins. It is roughly 20-70 μm in thickness. The material for the substrative layer of the film 133 is such resin as polyimide, polyamideimide, PEEK, PES and PPS, or such metal as SUS.

The film 133 is provided with an elastic layer, which is a layer of silicone rubber in which such thermally conductive filler as ZnO, Al₂O₂, SiC, and metallic silicon is dispersed. Further, it has a surface layer formed on the elastic layer by coating the elastic layer with PTFE, PFA, FEP, or the like.

The film 133 in this embodiment is provided with a substrative layer, an elastic layer, and a surface layer. The substrative layer is 50 μm in thickness, and is formed of an electrically conductive compound made by mixing electrically conductive filler in polyimide. The elastic layer is 240 μm in thickness, and is formed of a compound made by mixing metallic silicon into silicone rubber. The surface layer is formed by coating the elastic layer (silicone rubber layer) with PTFE. Here, PTFE is an abbreviation of polytetrafluoroethylene. PFA is an abbreviation of copolymer of tetrafluoroethyline and perfluoroalkylvinylether. FEP is an abbreviation of coplymer of tetrafluoroethylene and hexafluoropropyrene. PES is an abbreviation of polyethersulfone.

### 4) Pressure Roller 134

The pressure roller 134 is such a member that forms the nip N between itself and the film 133 by being pressed against the heater with the presence of the film 133 between itself and heater 132. It functions also as a member for rotationally driving the film 133. It is an elastic roller. It has: a metallic core formed of SUS, SUM, Al, or the like; an elastic layer formed on the peripheral surface of the metallic core of heat resistant rubber such as silicone rubber, fluorine rubber, or an elastic layer formed on the peripheral surface of the metallic core of foamed silicone rubber; and a release layer formed on the peripheral surface of the elastic layer, of PFA, PTFE, PEP, or the like. In this embodiment, the material for the metallic core was aluminum. The elastic layer was formed of silicone rubber, and was 4.0 mm in thickness. The release layer was formed of PFA, and was 50 μm in thickness.

### 5) Thermistor 138

A thermistor 138 is an element as a temperature detecting means for detecting the temperature of the ceramic heater 132. The temperature detected by the thermistor 138 is inputted into an engine controller (unshown). It is of the NTC (Negative Temperature Coefficient) type. That is, it reduces in resistance as temperature rises.

The temperature of the ceramic heater 132 is watched by the engine controller. The engine controller compares the detected temperature of the ceramic heater 132 with a target temperature level set in the engine controller, and adjusts the amount by which electric power is supplied to the heater 132. That is, the electric power to be supplied to the heater 132 is controlled so that the temperature of the heater 132 remains at a target level.

### (Equalization Process (Cooling Process))

As will be described later, in this embodiment, in a case where a large sheet of recording paper is conveyed through the fixing portion 130 immediately after a substantial number of small sheets of recording paper are conveyed through the fixing portion 130 in succession, an operation (equalization process) for cooling the overheated out-of-sheet-path portion of the fixing portion 130 before the large sheet of recording paper begins to be conveyed after the continuous conveyance of the small sheets of recording paper end. The definition of equalization process is as follows. The equalization process in this embodiment is such a process that rotates the film 133 and pressure roller 134 while the temperature of the heater 132 is kept lower than the target level of the fixation process. It may be referred to as equalization rotation.

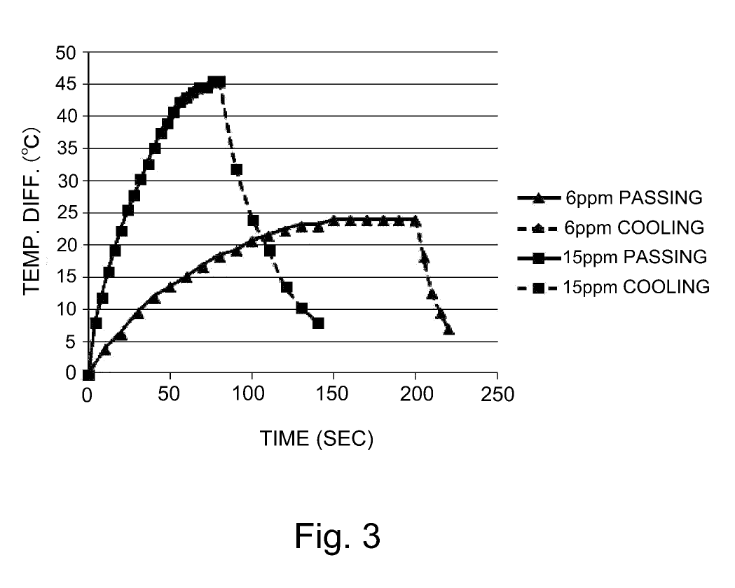

FIG. 3 is a graph which shows the relationship between the temperature difference between the sheet-path and out-of-sheet-path portions of the film 133, and the length of time which elapsed while 200 envelops of the COM10 size (small), which is 104.7 mm in width, were conveyed through the fixing portion 130 in succession. For example, when 200 envelops were conveyed at a throughput of 5 ppm (4 sec/sheet), it took 80 seconds to convey all of them. At the end of the conveyance of 200 small envelops, the temperature difference was roughly 45° C. If a large sheet of recording paper (A4 size) which is 210 mm in width is conveyed through the fixing portion 130 is conveyed in this condition, “high temperature offset” occurs across the areas which correspond in position to the out-of-sheet-path portions of the film 133, which occurs as a substantial number of small sheet of recording paper (COM10 size) are conveyed.

In this embodiment, in order to prevent the occurrence of high temperature offset, the equalization (cooling) process for making the film 133 uniform in temperature in terms of its widthwise direction is carried out before a large (210 mm in width) sheet of paper begins to be conveyed after the continuous conveyance of a substantial number of small sheets of papers. As a means for making the film 133 uniform in temperature in terms of its widthwise direction, it is effective to keep an image forming apparatus on standby immediately after the conveyance of a substantial number of small sheets of paper, until the temperature of the out-of-sheet-path portions of the film falls by certain degrees. However, if the image forming apparatus is kept on standby without rotating the film, it takes a substantial length of time for the temperature of the out-of-sheet-path portions of the film to substantially reduce. In comparison, if the temperature of the heater is kept at a level which is lower than the one for the fixation process while keeping the film and pressure roller rotating, it takes less time to reduce the temperature of the overheated out-of-sheet-path portions of the film than if the image forming apparatus is kept on standby without rotating the film and pressure roller.

By the way, it has been known that in the case of this apparatus, if the temperature difference between the sheet-path portion and out-of-sheet-path portions of the film is kept no more than 10° C., high temperature offset does not occur. For example, when the fixing portion 130 was cooled for 60 seconds after 20 envelops (which is equivalent to 20 small sheets of paper) were continuously conveyed through the fixing portion 130 at a throughput of 15 ppm, the temperature difference between the sheet-path portion and out-of-sheet-path portions of the film became roughly 8° C. Thus, when a large sheet (A4 size) of paper was conveyed through the fixing portion 130, high temperature offset did not occurred. In this case, the total length of time it took to complete the image forming operation was 140 seconds (80 seconds+60 seconds).

In comparison, if all of 20 envelops (which is equivalent to 20 small sheets of paper) were continuously conveyed through the fixing portion at a throughput of 6 ppm (10 seconds per sheet), that is, with sheet interval set longer, it takes 200 seconds. Here, “sheet interval time” means the length of time it takes for the leading edge of the following sheet of paper to enter the nip N after the trailing edge of the preceding sheet comes out of the nip N when two or more prints are made in succession. More concretely, it is the length of time which elapses between when the trailing edge of the preceding sheet of recording medium comes out of the nip of the pair of registration rollers 104 (FIG. 1), and when the leading edge of the following sheet of recording medium (paper) reaches the same pair of registration rollers 104.

In this case, after the last sheet of paper came out of the nip N, the temperature difference between the sheet-path portion and out-of-sheet-path portions of the film was roughly 24° C. Then, the equalization process (cooling process) was carried out for 20 seconds. Consequently, the temperature difference between the sheet-path and out-of-sheet-path portions of the film became roughly 9° C. Thus, when a large sheet (A4 size) of paper was conveyed through the fixing portion 130, high temperature offset did not occur. In this case, the total length of time it took to complete the printing operation was 220 second (200 seconds+20 second).

This total length of time of 220 seconds is longer than the abovementioned total length of time of 140 seconds which it took to carry out the equalization process (cooling process) after all of 20 small sheets of paper were continuously conveyed through the fixing portion 130 at a throughput of 15 ppm. However, if the equalization process (cooling process) is carried out for the period in which only a preset number of the last sheets of paper are conveyed through the fixing portion 130, the total length of time is 118 seconds, which is substantially shorter than 140 seconds. This matter will be described later in detail.

Here, referring to FIG. 3, there are two reasons why the latter case (6 ppm in throughput) is smaller in the temperature difference between the sheet-path and out-of-sheet-path portions of the film immediately after the completion of the conveyance of the small sheets of paper (before cooling process is started). Firstly, when the throughput is 15 ppm, the sheet interval time is 2.5 second (4 seconds−1.5 seconds), whereas when the throughput is 6 ppm, the sheet interval time is 8.5 seconds (10 seconds−1.5 second). Therefore, the temperature difference is more likely to be reduced in the latter case. Secondly, the longer the sheet interval time is, the more likely it is for the pressure roller to increase in temperature, and therefore, the smaller the amount of electric power necessary for fixation is.

Therefore, the temperature difference between the sheet-path and out-of-sheet-path portions of the film is smaller, and therefore, is shorter in the length of time necessary for the equalization process (cooling process), when the envelopes of COM10 size are conveyed at a throughput of 6 ppm than at a throughput of 15 ppm.

Based on this background knowledge, it is evident that in a case where a large sheet of paper is conveyed through the fixing portion 130 immediately after a substantial number of small sheets are continuously conveyed through the fixing portion 130, the lower the image forming apparatus is in throughput, the shorter the length of time required for the equalization process (cooling process) is. On the other hand, in a case where no large sheet of paper is conveyed through the fixing portion 130 after the conveyance of successive conveyance of a substantial number of small sheets of paper through the fixing portion 130, the higher the image forming apparatus is in throughput, the higher the apparatus is in productivity. In this embodiment, therefore, the image forming apparatus is reduced in throughput for a preset number of last small sheets of paper, only if a printing signal for printing on a large sheet of paper is received while printing is continuously done on a substantial number of small sheets of paper. With the implementation of this procedure, it is possible to reduce the length of time required for the equalization process (cooling process), and also, to reduce the total length of time required for the completion of the image forming operation.

### (Throughput-Down Control)

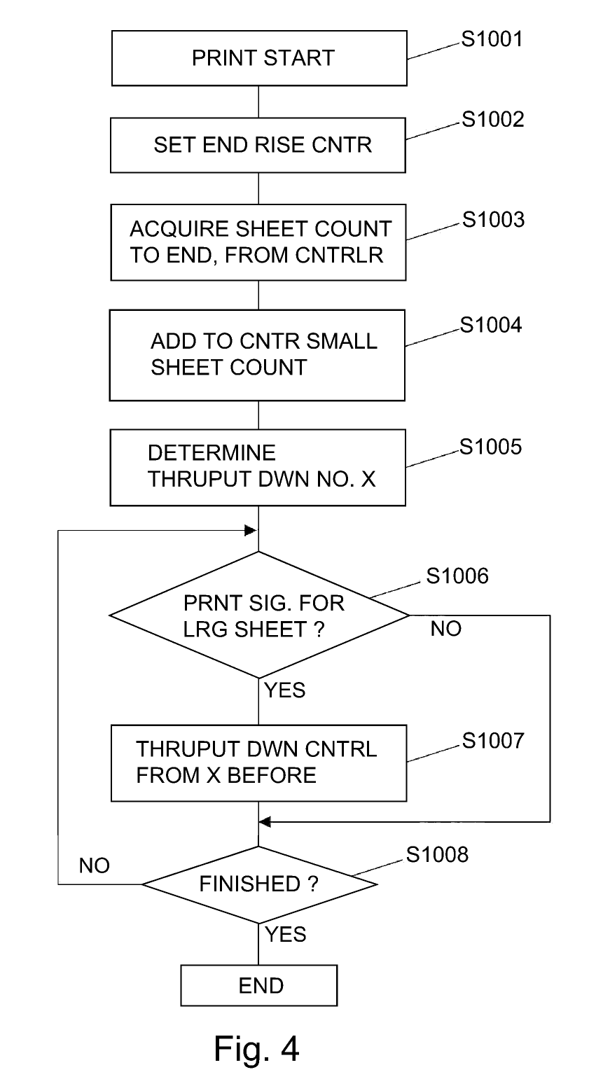

FIG. 4 is a flowchart of the control sequence, in this embodiment, for a printing operation in which small sheets of paper are conveyed through the fixing portion 130. First, as a printing operation is started in S1001 in response to an instruction to start a printing operation, the printing operation is started following the flowchart shown in FIG. 4. Next, an end portion overheat counter is set in S1002. Here, “end portion overheat counter” is a counter for counting small sheets of paper as the sheets are conveyed through the fixing portion 130. By the way, the sheet count can be weighted as will be described later.

In this embodiment, a control portion 200 (FIG. 1) decides whether or not the throughput-down control is to be executed, based on an index named end portion overheat counter. This counter is such an index that indicates an approximate temperature difference between the sheet-path portion and out-of-sheet-path portions of the film. More concretely, it is set so that the larger the number by which small sheets of paper are conveyed, the greater it is in value.

Here, in a case where the temperature difference between the sheet-path portion and out-of-sheet-path portions of the film is expected to be relatively small, for example, in a case where a printing operation is carried out after large sheets of paper were conveyed, or in a case where a printing operation is started after the elapsing of a substantial length of time after the completion of the preceding printing operation, even if the printing operation uses small sheets of paper as recording medium, the initial value for the index is set to zero. On the other hand, in a case where a printing operation begins to be carried out before a substantial length of time elapses after the completion of a printing operation which uses small sheets of paper as recording medium, the initial value for the index is set according to the number of small sheets of paper conveyed through the fixing portion and/or the elapsed length of time after the completion of the preceding printing operation.

Next, in S1003, the control portion 200 receives from the engine controller, the information regarding the sheets of paper until the printing operation ends. More concretely, the information is the width of sheets of paper which are going to be conveyed, the number of sheets of paper which are going to be conveyed (print count set by user), etc. In S1004, the number of sheets of paper which are no more than 210 mm in width is added to the value in the end portion overheat counter. In this case, the number of sheets of paper may be weighted according to the width of the sheets. That is, the counter may be weighted so that the narrower (smaller) the sheets are, the larger the coefficient of weighting is set.

Next, in S1005, the value for the throughput-down count X is set according to the end portion overheat counter. Here, “throughput-down count X” is the number (preset number) of sheets of paper which are to be conveyed through the fixing portion 130 at a throughput of 6 ppm. That is, in this embodiment, in a printing operation in which small sheets of paper are continuously conveyed, the image forming apparatus 100 is reduced (slowed down) in throughput for the last few (X) sheets of paper.

Setting a value for the throughput-down count X is equivalent to setting the timing with which the image forming apparatus 100 is to be changed (reduced in speed) in throughput from the first one (15 ppm) to the second one (6 ppm). For example, if the throughput-down count X is set to three by the end portion overheat counter, the timing with which the image forming apparatus 100 is to be changed in throughput is when the leading edge of the 18th small sheet of paper reaches the pair of registration rollers 104 (FIG. 1). Further, the timing is affected by the value in the end portion overheat counter. That is, it is reasonable to say that there are multiple timings with which the image forming apparatus 100 is to be reduced in throughput.

Referring to Table 1, if the amount of the end portion overheating is greater than, or equal to, a referential value (value in end portion overheat counter is 11), the control portion 200 (FIG. 1) changes the image forming apparatus 100 in throughput from the first one to the second one, according to the amount of the end portion overheating. On the other hand, if the amount of the end portion overheating is smaller than the referential value (11 in end portion overheating counter), the control portion 200 does not change the image forming apparatus 100 in throughput.

TABLE 1

| Counter value | Throughput down No. |
|---|---|
| 0-10 | 0 |
| 11-16 | 1 |
| 17-24 | 2 |
| 25-44 | 3 |
| 45- | 4 |

In S1006, it is determined whether or not there has been received a signal for switching recording medium from those being used to a recording medium which is wider than those being used. That is, it is determined whether or not there has been received a signal to start using a large sheet of paper for the on-going image forming operation in which a substantial number of small sheets of paper are conveyed (through fixing portion) at the first throughput (15 ppm) as a fixation count per unit length of time.

If the control portion 200 determines that this signal has been received, it proceeds to S1007. If it determines that the signal has not been received, it proceeds to S1008. In S1007, the control portion 200 reduces the image forming apparatus 100 in throughput before it starts conveying the X-th large sheet of paper (counting backward from the last sheet of paper in the printing operation, based on the preset throughput-down sheet count. As the image forming apparatus 100 is reduced in speed, the fixing portion 130 improves in image quality (film (fixing portion)) is reduced faster in temperature difference between its sheet-path portion and out-of-sheet-path portions, and amount by which out-of-sheet-path portions of heater generates becomes smaller, because amount by which heater is supplied with electric power is reduced). Therefore, it is possible to lower the target temperature for the heater.

Next, in S1008, the control portion 200 determines whether or not the printing operation is completed. If it determines that the operation has not been completed, it returns to S1006. If it determines that the operation has been completed, it ends the printing operation.

Here, the values for the throughput-down count in Table 1 are set in consideration of the following factors. First, regarding the temperature difference between the sheet-path portion and out-of-sheet-path portions of the film (fixing portion), the highest level the temperature difference reaches is affected by the throughput of the image forming apparatus (fixing portion). For example, when a substantial number of small sheets of paper are conveyed at 15 ppm, the temperature difference reached roughly 49° C. When they are conveyed at 6 ppm, the temperature difference reached roughly 24° C.

If the image forming apparatus 100 is reduced in throughput (to 6 ppm) while it is operated at a throughput of 15 ppm and the temperature difference is higher than 49° C., the temperature difference gradually reduces to 24° C., which is the saturation level when the sheets of paper are conveyed at 15 ppm. The length of time (sheet count) it takes for the temperature difference to come close to the saturation level (preset temperature level at preset amount of pressure) is affected by the temperature difference prior to the starting of the throughput-down control. In this embodiment, therefore, the control portion 200 changes the throughput-down sheet count according to the value of the end portion overheat counter which shows the temperature difference, so that the image forming apparatus 100 remains highest in productivity.

By reducing the speed at which small sheets of paper are conveyed following the flowchart described above, it is possible to prevent the out-of-sheet-path portions of the film (fixing portion) from overheating, and therefore, to reduce the length of time necessary to idle the image forming apparatus 100 (rotate film and pressure roller) to reduce the length of time necessary to make the fixing portion roughly uniform in temperature. The followings are the tests carried out to confirm these effects.

### <Test 1>

The length of time it took to make it possible for a sheet of paper of A4 size to be conveyed through the fixing portion without allowing the high temperature offset to occur, after 20 envelops (COM10 size) were continuously conveyed when the throughput-down control is carried out, was compared with that when the throughput-down control was not carried out. The throughput-down sheet count for the throughput-down control was set according to a table prepared in advance. In S1001, the tests were started when the fixing device (fixing portion) was sufficiently cold. Therefore, the initial value for the end portion overheating counter was set to zero.

Next, in S1003, the control portion 200 received information that the number of envelops of COM10 size, which are to be conveyed through the fixing device until the printing operation ends was 20. In S1004, a certain value is added to the end portion overheating counter. However, envelops of COM10 size are substantially narrower than a sheet of paper of A4 size. Therefore, the end portion overheating count was weighted by two. Thus, the end portion overheating counter was 40.

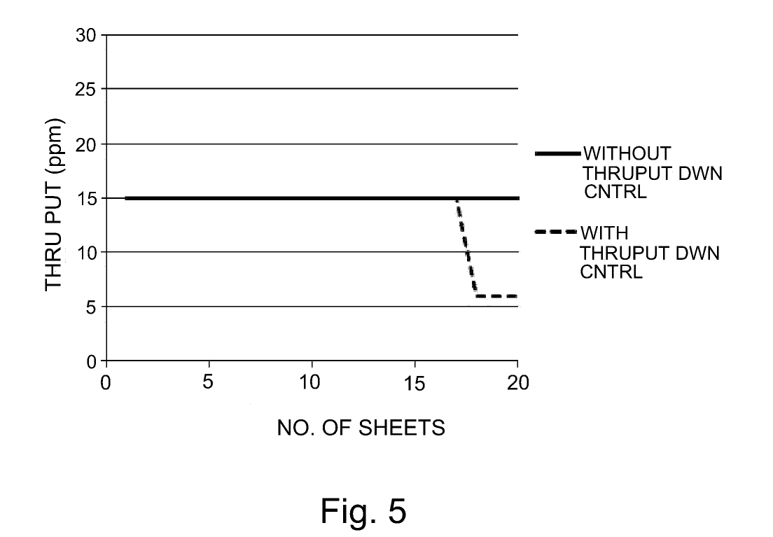

In S1005, the throughput-down sheet count was set to 3 with reference to Table 1. Therefore, while the first to 17th sheets of paper were conveyed, the image forming apparatus 100 (fixing portion) was operated at a throughput of 15 ppm (first throughput), and then, while the 18th sheet and the sheets thereafter were conveyed, the image forming apparatus 100 was operated at a throughput of 6 ppm (second throughput), as shown in FIG. 5.

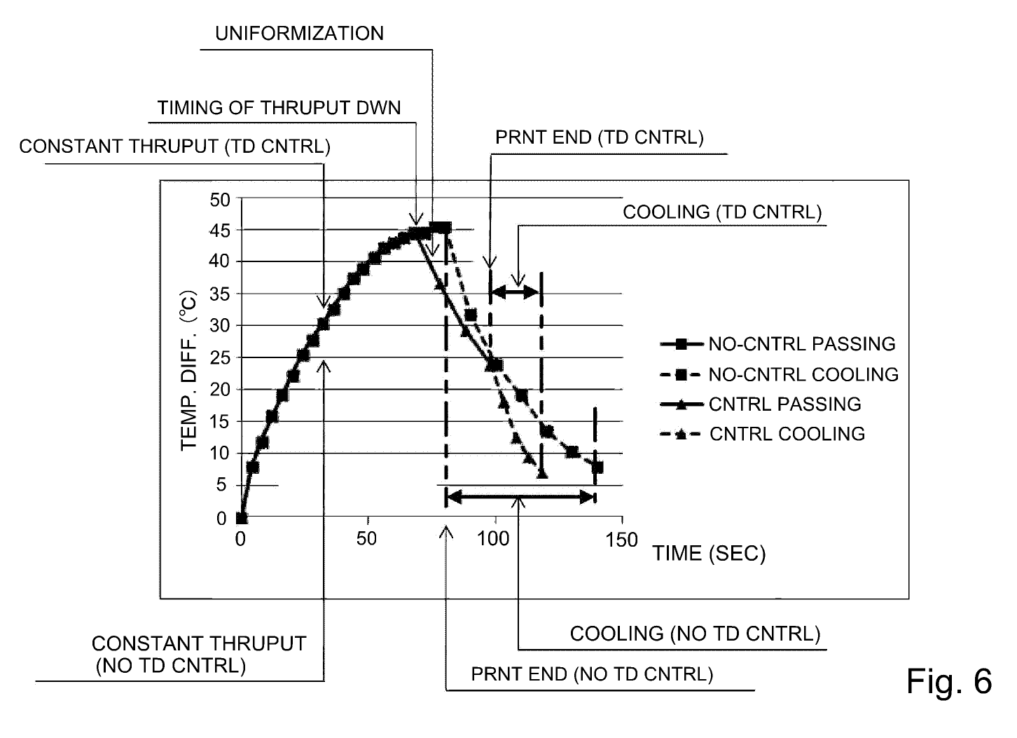

Shown is FIG. 6 is the relationship between the temperature difference between the sheet-path portion and out-of-sheet-path portions of the film, and the elapsed length of time, when the throughput-down control was carried out and when it was not carried out. First, when the TD control was not carried out, 20 envelops (small sheets of paper) were conveyed at 15 ppm (4 seconds per sheet), and the temperature difference reached roughly 45° C. Then, the equalization process (cooling process) was started to rotate the film and pressure roller to make the film roughly uniform in temperature, until the temperature difference becomes no more than 10° C. below which high temperature offset is unlikely to occur. FIG. 6 shows that it took roughly 60 seconds to reduce the temperature difference to no more than 10° C.

In comparison, when the TD control was carried out, the sheet interval (time) became longer, and the amount by which the heater was supplied with electric power was reduced, at 18th sheet and thereafter. Therefore, the temperature difference gradually reduced. By the time when the conveyance of the 20th sheet ended (end of printing operation), the temperature difference had reduced to roughly 24° C. When the equalization process (cooling process) was started the temperature difference was 24° C., it took roughly 20 seconds to start printing on the next sheet.

In both the case where the TD control was not carried out and the case where the TD control was carried out, the temperature difference was roughly 24° C. when the elapsed length of time was roughly 100 seconds. Yet, the two cases were different in the rate at which the temperature difference reduced. The following is the reason therefor. That is, although the two cases are the same in the value of the temperature difference, they are different in the absolute value of the difference. This is the reason. To describe in greater detail, in the case where no TD control was carried out, when roughly 100 seconds had elapsed and the temperature difference was roughly 24° C., roughly 20 seconds had elapsed from the ending of the printing operation. Further, the temperature of the sheet-path portion of the film was 115° C., and that of the out-of-sheet-path portions of the film was 139° C.

In comparison, in the case where the TD control was carried out, when the temperature difference was roughly 24° C. and roughly 100 seconds had elapsed, it was right after the printing operation ended. Thus, the temperature of the sheet-path portion of the film was 150° C., and that of the out-of-sheet-path portions of the film was 170° C. It is evident from the comparison of the two cases that when there is the TD control, the temperatures of the two portions of the film are greater in absolute value, and therefore, the temperature difference reduces faster.

Here, the two cases are compared in terms of the length of time necessary to make it possible for a large sheet of paper to begin to be conveyed after the continuous conveyance of a substantial number of small sheets of paper. Table 2 shows: the length of time it takes to convey the small sheets of paper; the length of time it takes to idle the film and pressure roller to reduce the temperature difference; and the total length of time it takes to complete the printing operation, when the TD control is not carried out. It shows also: the length of time it takes to convey the small sheets of paper; the length of time it takes idle the film and pressure roller to reduce the temperature difference; and the total length of time it takes to complete the printing operation, when the TD control is carried out. In a case where the TD control is carried out, it takes longer to convey the small sheets of paper, but the length of time the film and pressure roller have to be idled to make the film uniform in temperature less. Thus, the overall length of time to complete the printing operation is shorter.

Further, in a case where only small sheets of paper are conveyed (printing command to print image on large sheet of paper is not issued while images are fixed to small sheets of paper), the TD control is not carried out. That is, the small sheets of paper are continuously conveyed at 15 ppm (four seconds per sheet). Therefore, the printing operation can be completed in 80 seconds.

TABLE 2

| | |
|---|---|
| Without TD control | With TD control |

| | | | | |
|---|---|---|---|---|
| Small size sheet | 80 | sec | 98 | sec |
| Uniformization | 60 | sec | 20 | sec |
| Total | 140 | sec | 118 | sec |

In this embodiment, when the image forming apparatus 100 is used for an image forming operation in which a large sheet of paper is conveyed immediately after the conveyance of a substantial number of small sheets of paper, the apparatus 100 can be increased in productivity by carrying out the TD control. Further, in a case where only small sheets of paper are conveyed, the TD control is not to be carried out.

In this embodiment, the choice of the throughput to which the image forming apparatus 100 is to be reduced for the TD control is only one (6 ppm). However, it may be a throughput other than 6 ppm, as long as it is no higher than 15 ppm. Further, two or more values may be provided as the throughput choices to which the image forming apparatus 100 is reduced in throughput for the TD control, so that a proper throughput can be selected (according to value of end portion overheat counter).

Further, in this embodiment, the throughput-down control was carried out when the image forming apparatus 100 was operated in a mode in which small sheets of paper are continuously conveyed at 15 ppm. However, the throughput-down control can be applied to the image forming apparatus 100 when the apparatus 100 is operated in one of the following modes. For example, the throughput-down control may be carried out, as the means for preventing the out-of-sheet-path portions of the film from overheating, when the apparatus 100 is operated in such a mode that the apparatus 100 is gradually reduced in speed while small sheets of paper are continuously conveyed. For example, it is assumed here that a printing operation is started with the use of small sheets of paper, and a printing command for printing on a large sheet of paper is not inputted while the printing operation is carried out on the small sheets of paper, and also, that the image forming apparatus 100 is changed in throughput in such a manner that while the first to 10th sheets of paper are conveyed, the throughput is kept at 15 ppm; 11th to 20th sheets of paper, 12 ppm; 21st to 30th sheets, 8 ppm; and 41st sheet and thereafter, 6 ppm. If the control in this embodiment is applied to this case, the printer operates in the following sequence: As an operator gives the printer such an instruction that it is to output 20 prints with the use of small sheets of paper, with the throughput-down count X set to 5; and if an instruction to print on a large sheet of paper is inputted while small sheets of paper are conveyed, the printer operates at 15 ppm up to 10th sheet of paper; 15 ppm up to 15th; and 12 ppm, up to 20th sheet of paper.

Further, in the case of an image forming apparatus which are shared by two or more users, the image forming apparatus may be designed so that it is only when both a printing instruction to use small sheets of paper, and a printing instruction to use large sheets of paper, are issued by the same operator, that it is decided whether or not the TD control is to be carried out in a printing operation in which a large sheet of paper is conveyed immediately after a substantial number of small sheets of paper are continuously conveyed.

According to this embodiment, the throughput-down control is carried out with preset timing only in a printing operation in which a large sheet of paper is conveyed immediately after a substantial number of small sheets of paper are continuously conveyed. Thus, it is possible to reduce the length of time necessary for the equalization process (cooling process), and therefore, to reduce the total length of time to complete the printing operation. Further, it is possible to keep the image forming apparatus high in productivity in both a printing operation in which only small sheets of paper are conveyed, and a printing operation in which a large sheet of paper is conveyed immediately after the conveyance of a substantial number of small sheets.

### Embodiment 2

In the first embodiment, the temperature difference between the sheet-path portion and out-of-sheet-path portions of the film was predicted from the condition under which small sheets of paper are conveyed, and whether or not the TD control is to be carried out when a large sheet of paper is conveyed immediately after the continuous conveyance of a substantial number of small sheets of paper is decided based on the prediction. However, in the case of a printing operation in which both large sheets of paper and small sheets of paper are conveyed in such a manner that a large sheet of paper and a small sheet of paper are alternately conveyed, it was sometimes rather difficult to predict the temperature difference. In this embodiment, therefore, in order to more precisely predict the temperature difference between the sheet-path portion and out-of-sheet-path portions of the film, the fixing apparatus was provided with a thermistor for measuring the temperature of the out-of-sheet-path portions of the heater (temperature of out-of-sheet-path portions of fixing portion), in addition to the thermistor for adjusting the amount by which electric power is supplied to the heater.

The image forming apparatus 100 and its fixing portion 130 in this embodiment are the same in basic structure as those in the first embodiment. Thus, the structural members of the image forming apparatus 100 and its fixing portion 130 in this embodiment, which are the same in structure as the counterparts in the first embodiment are given the same referential codes as those given to the counterparts, and are not going to be described here.

### (Central Thermistor and End Portion Thermistor)

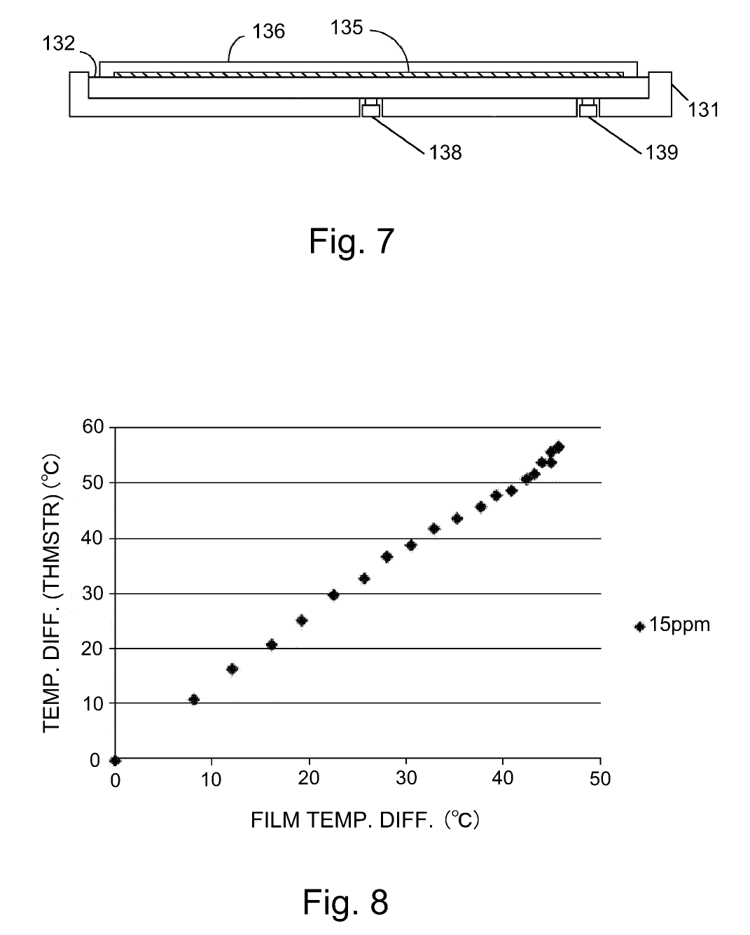

FIG. 7 is a sectional view of a heater 132, which is on the inward side of the loop which the film 133 forms, at a plane which is parallel to the lengthwise direction of the heater 132. The only difference of this embodiment form the first embodiment is that the fixing portion 130 is provided with an end portion thermistor 139 disposed in the adjacencies of one of the lengthwise end portions of the heater 132, in addition to a central thermistor disposed in the adjacencies of the lengthwise center of the heater 132.

Regarding the concrete positional relationship between the central thermistor 138 and end portion thermistor 139 in terms of the lengthwise direction of the fixing portion 130, the dimension of the heating member 135 in terms of its lengthwise direction is 222 mm, for example. This dimension of the heating member 135 is decided based on the dimension (length) which the heating member 135 is required to satisfactorily fix the unfixed toner image on a sheet of paper even when a largest sheet of paper, in terms of the lengthwise direction of the fixing portion, is conveyed. By the way, the image forming apparatus 100 is structured so that, in terms of the lengthwise direction of its heating member, when a sheet of paper is conveyed, its center coincides with the center of the heating member.

The central thermistor 138 is disposed in the adjacencies of the center of the heating member in terms of the lengthwise direction of the heating member 135, in order to ensure that it always falls within the sheet-path portion regardless of the size of a sheet of paper. As for the end portion thermistor 139, it is disposed 105 mm away from the center of the heating member in terms of the lengthwise direction of the heating member 135, in order to ensure that when a sheet of paper, which is narrower in terms of the lengthwise direction of the fixing portion than a sheet of paper of A4 size is conveyed, the temperature of the out-of-sheet-path portions can be measured.

FIG. 8 shows the relationship between the temperature difference which occurred between the sheet-path portion and out-of-sheet-path portions of the surface of the film when 20 envelops of size COM 10 size were continuously conveyed at a throughput of 15 ppm (when small sheets of paper were continuously conveyed), and the temperature detected by the central thermistor 138 and the temperature detected by the end portion thermistor 139. There is a correlation between the two temperature differences, and therefore, the temperature difference between the sheet-path portion and out-of-sheet-path portions of the film can be more precisely estimated from the difference between the temperature measured by the central thermistor 138 and that by the end portion thermistor 139 (difference between the temperatures detected by two thermistors, one for one). In this embodiment, therefore, the difference between the temperatures detected by the two thermistors, one for one, was used to more accurately predict the amount of the overheating of the out-of-sheet-path portions of the film, than in the first embodiment.

### (Throughput-Down Control)

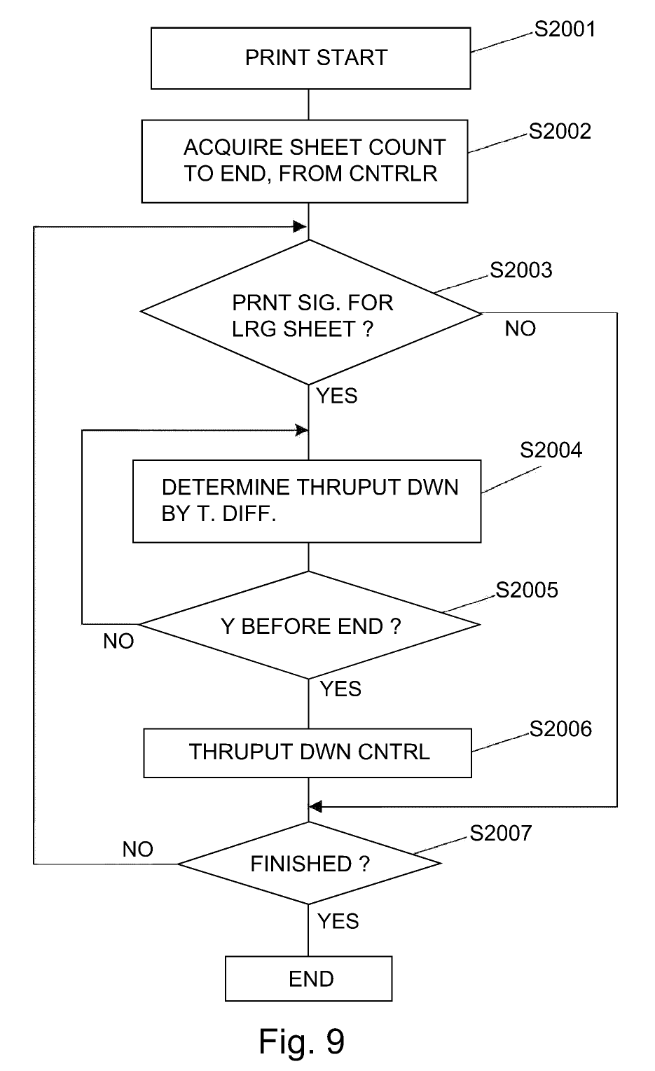

FIG. 9 is a flowchart of the throughput-down control sequence in this embodiment. In this embodiment, the difference between the temperature detected by the central thermistor 138 and that detected by the end portion thermistor 139 was used as an index for deciding whether or not the throughput-down control is to be carried out.

Next, the flowchart is concretely described. First, in S2001, the control portion 200 starts a printing operation in response to a command it received. Next, in S2002, the control portion 200 receives the information regarding the number of sheets of paper which are going to be conveyed before the printing operation is completed. In S2003, it determines whether or not a printing signal for printing on a sheet of paper which is wider than the sheets of paper which are currently in use has been received. If it determines that this signal has been received, it proceeds to S2004. If it determines that the signal has not been received, it proceeds to S2007.

In S2004, the control portion 200 selects a value for the throughput-down count Y, according to the difference between the two temperatures detected by the two thermistors, one for one, from a table prepared in advance. Table 3 shows the relationship between the difference between the temperatures detected by the two thermistors, one for one, and the throughput-down count. The greater the temperature difference, the greater the throughput-down count. For example, if the temperature difference is no more than 30° C., the throughput-down count is 0, which means that the throughput-down control is not carried out.

In S2005, the control portion 200 determines whether or not the printing operation has reached the point at which it begins to print on the Yth sheet of paper, counting backward from the last sheet of paper to be conveyed in the printing operation. If it determines that the operation has reached the point, it proceeds to S2006 in which it carries out the throughput-down control (TD control). If it determines that the operation has not reached the point, it returns to S2004, in which it resets the value for the throughput-down count Y. Therefore, this embodiment makes it possible to deal with such a situation that the throughput-down control has to be carried out with earlier timing than expected, due to the overheating of the out-of-sheet-path portions of the film. By the way, in the first embodiment, the value for the throughput-down count X was set before the print signal for printing on a sheet of paper which is wider than the sheets of paper which are being conveyed, is received. This embodiment makes it possible to set the value for the throughput-down count, after the reception of the print signal to start printing on a sheet of paper which is wider than the sheets of paper which are being conveyed.

In S2007, the control portion 200 determines whether or not the printing operation has been completed. If it determines that the operation has not been completed, it returns to S2003. If it determines that the operation has been completed, it ends the operation; it remains at the end of the flowchart.

TABLE 3

| Temperature difference (degree) | Throughput down No. |
|---|---|
| <30 | 0 |
| ≥30 and <40 | 1 |
| ≥40 and <49 | 2 |
| ≥49 and <58 | 3 |
| ≥58 | 4 |

According to this embodiment, the film temperature is predicted by following the flowchart described above. Therefore, the film temperature can be more accurately predicted than in the first embodiment which uses only the end portion overheat counter. For example, in a case where small sheets of paper and large sheets of paper are alternately conveyed, the temperature of the out-of-sheet-path portions of the film does not increase as high as in a case where only small sheets of paper are continuously conveyed. However, the end portion overheating counter is increased by a preset value. Therefore, it is possible that the throughput-down control will be unnecessarily carried out.

In comparison, in this embodiment, in a case where small sheets of paper and large sheets of paper are alternately conveyed, the difference between the temperature detected by the central thermistor 138 and end portion thermistor 139 does not increase, and therefore, the throughput-down control is not carried out. Therefore, the image forming apparatus 100 remains higher in overall productivity than in the first embodiment.

### Modifications

In the foregoing, a couple of preferred embodiments of the present invention were described. However, these embodiments are not intended to limit the present invention in scope. That is, these embodiments may be variously modifiable within the scope of the present invention. By the way, the measurements, materials, and shapes of the structural components of the image forming apparatus and its fixing portion, and their positional relationship, in the preceding embodiments are to be altered according to the structure of the image forming apparatus and its fixing portion to which the present invention is applied, and also, according to the various conditions under which they are used.

### Modification 1

In the embodiments described above, in a case where a command to start conveying a large sheet of paper is received while a substantial number of small sheets of paper are continuously conveyed, the throughput-down control was carried out only while a preset number of the last small sheets of paper, which includes the last sheet, are conveyed. For example, in a case where 20 small sheets of paper are continuously conveyed, the control portion 200 determines, based on the predicted difference in temperature between the central portion and end portions of the film in terms of the widthwise direction of the film, that the throughput-down count is 3, the throughput-down control is carried out while the 18th to 20th small sheets of paper were conveyed.

However, it is not mandatory that the throughput-down control is carried out while a preset number of last small sheets of paper, which includes the last small sheets of paper, are conveyed. For example, if it is determined, based on the predicted difference in temperature between the center portion and end portions of the film in terms of the widthwise direction of the film, that the throughput-down count is three, the throughput-down control may be carried out only while the 17th to 19th small sheets of paper, which do not include the last small sheet of paper, are continuously conveyed. In this case, the 20th small sheet of paper is to be conveyed at the same throughput as the 16th small sheet of paper and the prior sheets.

Similarly, it is not mandatory that if it is determined, based on the predicted difference in temperature between the center portion and end portions of the film in terms of the widthwise direction of the film, that the throughput-down count is one, the throughput-down control is to be carried out only for the last (20th) small sheet of paper. For example, if it is determined, based on the predicted difference in temperature between the center portion and end portions of the film in terms of the widthwise direction of the film, that the throughput-down count is one, the throughput-down control may be carried out for only one (19th sheet, for example) of the last small sheets of paper, which does not include the literally last small sheet of paper.

### Modification 2

The change in throughput from the first one to the second one may be made by changing (reducing) the speed with which recording medium is conveyed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-141665 filed on Jul. 21, 2017, which is hereby incorporated by reference herein in its entirety.

What is claimed is:

1. An image forming apparatus comprising:
an image forming portion configured to form a toner image on a recording material;
a fixing portion configured to heat and fix the toner image formed on the recording material; and
a controller configured to control said apparatus which is operable to form an image on the recording material having a first size and the recording material having a second size smaller than the first size,
wherein when a print instruction on the recording material of the first size during a period in which a print is formed on the recording material of the second size at a first throughput, said controller controls said apparatus so as to print on the recording material of the second size at a second throughput which is lower than the first throughput.

2. An apparatus according to claim 1, wherein said controller executes printing at the second throughput on the last one of a number, selected by a user, of the recording materials of the second size.

3. An apparatus according to claim 1, wherein said controller sets a number of prints to be formed at the second throughput, in accordance with the number of prints on the recording material of the second size.

4. An apparatus according to claim 1, wherein said controller sets a number of prints to be formed at the second throughput, in accordance with a temperature of a portion of said fixing portion in which the recording material of the second size does not pass.

5. An apparatus according to claim 1, wherein said controller sets a number of prints to be formed at the second throughput, in accordance with a difference between the temperature of a portion of said fixing portion in which the recording material of the second size passes and a temperature of a portion of said fixing portion in which the recording material of the second size does not pass.

6. An apparatus according to claim 1, wherein in a period between the printing on the recording material of the second size and the printing on the recording material of the first size, a process of uniformizing the temperature of said fixing portion along a longitudinal direction of said fixing portion.

7. An apparatus according to claim 6, wherein said fixing portion includes a heater and first and second rotatable members configured to nip and feed the recording material, wherein the process includes rotating said first and second rotatable members while heat generation of said heater is stopped or suppressed as compared with that during a normal fixing process operation.

8. An apparatus according to claim 7, wherein said first rotatable member includes a cylindrical film.

9. An apparatus according to claim 8, wherein said heater is in contact with an inner surface of said film.

10. An apparatus according to claim 9, wherein said heater is cooperative with said second rotatable member to provide a fixing nip through said film to nip and feed the recording material
